(19) United States
(12) Patent Application Publication
(10) Pub. No.: US 2026/0058451 A1
(43) Pub. Date: Feb. 26, 2026

(54) CONVERTER POWER SUPPLY JUNCTION BOX ADAPTER

(71) Applicant: Cleanlife Energy LLC, Valley View, OH (US)

(72) Inventor: Murray FREEMAN, Austin, TX (US)

(73) Assignee: Cleanlife Energy LLC, Valley View, OH (US)

(21) Appl. No.: 19/278,894

(22) Filed: Jul. 24, 2025

Related U.S. Application Data
(60) Provisional application No. 63/684,977, filed on Aug. 20, 2024.

(51) Int. Cl. H02G 3/08; G08B 17/10; H02M 7/00

(52) U.S. Cl. CPC H02G 3/081; G08B 17/10; H02M 7/003

(57) ABSTRACT

A power supply adapter is configured for installation within an electrical junction box to enable both high-voltage and low-voltage circuitry to coexist while maintaining compliance with NEC Code requirements. The adapter includes a high-to-low voltage converter and a separator plate that divides the junction box into electrically isolated high-voltage and low-voltage subcompartments. The converter is housed entirely within the low-voltage subcompartment, and the separator plate is formed from a fire-resistant, electrically insulative material. The power supply adapter reduces installation costs and material usage by allowing low-voltage devices, such as smoke detectors, to be powered from existing high-voltage infrastructure without requiring additional junction boxes. The power supply adapter may be used as part of a smoke detector kit comprising low-voltage detectors, interconnecting signal wires, and NEC-compliant installation instructions.

### TECHNICAL FIELD

The present disclosure relates generally to power supplies and more particularly to a drop-in converter power supply adapter for an electrical junction box.

### BACKGROUND

Articles 724 and 725 of the National Fire Prevention Association’s (“NFPA”) 2023 National Electrical Code (“NEC Code”) categorizes electrical infrastructure in commercial and residential buildings into high-voltage class 1 and low-voltage class 2 and class 3 circuits. High-voltage class 1 circuits are used to power outlets and appliances, while low-voltage circuits (such as those operating in class 2 and class 3 circuits) support control systems, sensors, communications, and signaling devices. To house both high-voltage and low-voltage circuits, electricians commonly use electrical junction boxes (also referred to as “gang boxes”), which provide a fire-resistant, electrically nonconductive enclosure for compliant in-wall installation.

Section 725.136 of the NEC Code states that “Cables and conductors of class 2 and class 3 circuits shall not be placed in any cable, cable tray, compartment, enclosure, manhole, outlet box, device box, raceway, or similar fitting with conductors of power, class 1, non-power-limited fire alarm circuits, and medium-power network-powered broadband communications circuits.” Consequently, NEC regulations prohibit combining class 1 (high-voltage) and class 2 or 3 (low-voltage) circuits within the same junction box. This results in the need for separate junction boxes when both circuit types are required in close proximity, as in integrated control systems or alarm networks.

Many appliances (such as lighting controls, manufacturing machinery, and smart devices) require both high-voltage power and low-voltage signaling. Because converters that step down voltage are classified as part of the low-voltage circuit, low-voltage circuits cannot be installed within the same junction box as high-voltage components. Electricians are therefore forced to either install multiple junction boxes—one for each class of circuit—or use only Class 1 wiring for all connections, even where class 2 would provide a more efficient wiring solution. These wiring inefficiencies increase construction costs, reduce copper efficiency, and negatively impact aesthetics, particularly in residential buildings where wall space and appearance are more closely scrutinized. In some cases, converters are installed externally as plug-in devices between a wall and the appliance, resulting in converters that are tripping hazards for appliance users.

### SUMMARY

Accordingly, there is a need for an apparatus that enables the transition from class 1 to class 2 circuitry within a pre-installed electrical junction box that also contains class 1 circuitry, while complying with NEC electrical class separation requirements. Such a solution would reduce material and installation costs, simplify wiring for dual-voltage systems, and enable more efficient, code-compliant electrical designs in modern buildings.

The present disclosure relates to a power supply adapter configured for “drop in” installation within an electrical junction box, enabling both high-voltage and low-voltage circuitry to coexist while maintaining compliance with electrical code requirements, such as those established by the NEC Code. The adapter includes a high-to-low voltage converter that receives class 1 power from high-voltage input wires and delivers class 2 power through low-voltage output wires. The adapter is designed to simplify dual-voltage installations by allowing both circuit types to be housed within a single gangbox without requiring separate enclosures.

To ensure the electrical and physical separation mandated by NEC Code, the power supply adapter includes a separator plate that divides the junction box into a high-voltage subcompartment and a low-voltage subcompartment. The separator plate is formed from a fire-resistant and electrically insulative material and is mechanically coupled to the converter. The converter is positioned entirely within the low-voltage subcompartment, isolating the converter’s components from any class 1 wiring located in the high-voltage compartment. The separator plate ensures that circuits from different NEC classes do not share the same enclosed space without separation, thereby maintaining code compliance and reducing fire and shock hazards.

Each subcompartment corresponds in size to a single gang section of the junction box. In a double-gang junction boxes, for example, the separator plate may bisect the box so that one gang section serves as the high-voltage compartment and the other as the low-voltage compartment. The high-voltage wires may enter their compartment directly and, in some embodiments, pass through the separator plate to deliver power to the converter located in the low-voltage compartment. The low-voltage output wires may then extend either through the rear of the junction box—connecting to in-wall devices—or through a front faceplate orifice to power external appliances. The faceplate and separator plate may be formed as part of the converter housing or coupled separately, depending on design requirements.

As used herein, the term “drop-in” refers to a form factor and installation method by which the power supply adapter may be inserted directly into an existing junction box without requiring structural modification to the box or surrounding wall. A drop-in configuration allows the power supply adapter to be installed using the junction box’s existing interior volume, mounting geometry, and faceplate coverage. Once inserted, the adapter may be secured in place using screws, bolts, clips, rivets, adhesives, magnets, or nails, and may be covered with a faceplate to allow the unit to integrate with standard electrical hardware in a flush-mounted configuration.

The power supply adapter may be provided as part of a kit that includes low-voltage smoke detectors, interconnecting signal wires, and NEC-compliant installation instructions. By enabling the use of class 2 wiring in place of more costly class 1 wiring, and by eliminating the need for additional junction boxes to house low-voltage converters, the system reduces material and installation costs. The disclosed apparatus is especially advantageous in residential or retrofit contexts where wall space, appearance, and budget constraints make the addition of new gangboxes undesirable. This design provides a streamlined, code-compliant solution for integrating power converters and low-voltage components into modern electrical infrastructure.

In an exemplary system/method, the power supply adapter may include [independent claims]….

In one or more embodiments, the power supp[ly adapter may include one or more of [dependent claims]…

While a number of features are described herein with respect to embodiments of the invention; features described with respect to a given embodiment also may be employed in connection with other embodiments. The following description and the annexed drawings set forth certain illustrative embodiments of the invention. These embodiments are indicative, however, of but a few of the various ways in which the principles of the invention may be employed. Other objects, advantages and novel features according to aspects of the invention will become apparent from the following detailed description when considered in conjunction with the drawings.

### BRIEF DESCRIPTION OF THE DRAWINGS

FIG. 1 is a front elevation view of an embodiment of a power supply adapter for an electrical junction box.

FIG. 2 is a front-side view of the adapter of FIG. 1.

FIG. 3 is a right-side view of the adapter of FIG. 1.

FIG. 4 is a left-side view of the adapter of FIG. 1.

FIG. 5 is a top-side view of the adapter of FIG. 1.

FIG. 6 is a view of an exemplary electrical junction box and junction box cover plate.

FIG. 7 is an exploded view showing how the junction box, power supply adapter, and cover plate fit together.

FIG. 8 is front-side elevated view of the power supply adapter attached to an electrical junction box.

FIG. 9 is a cross sectional view of FIG. 8.

FIG. 10 shows a front view of a junction box containing both a power supply adapter and an electrical switch or outlet, shielded by a cover plate.

### DETAILED DESCRIPTION

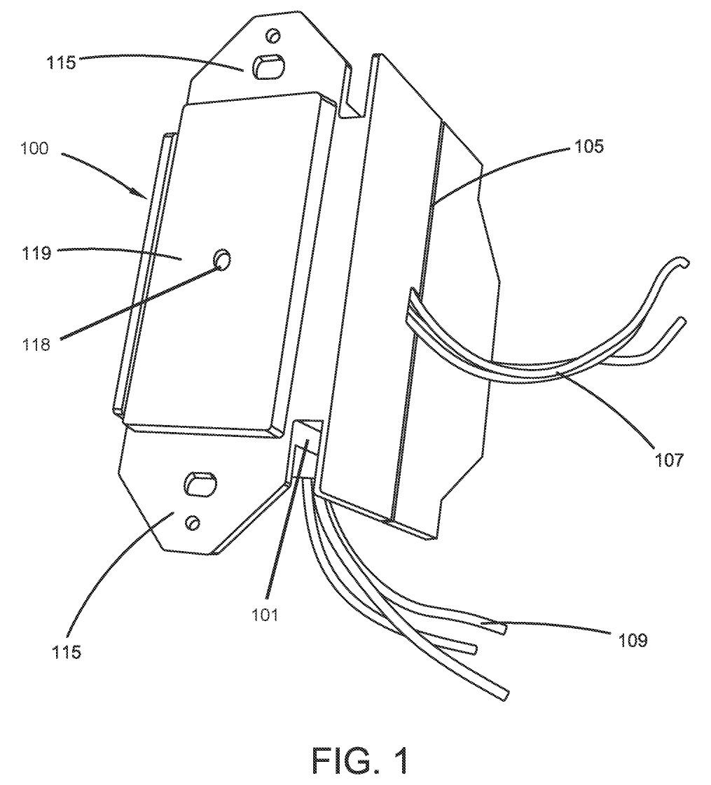

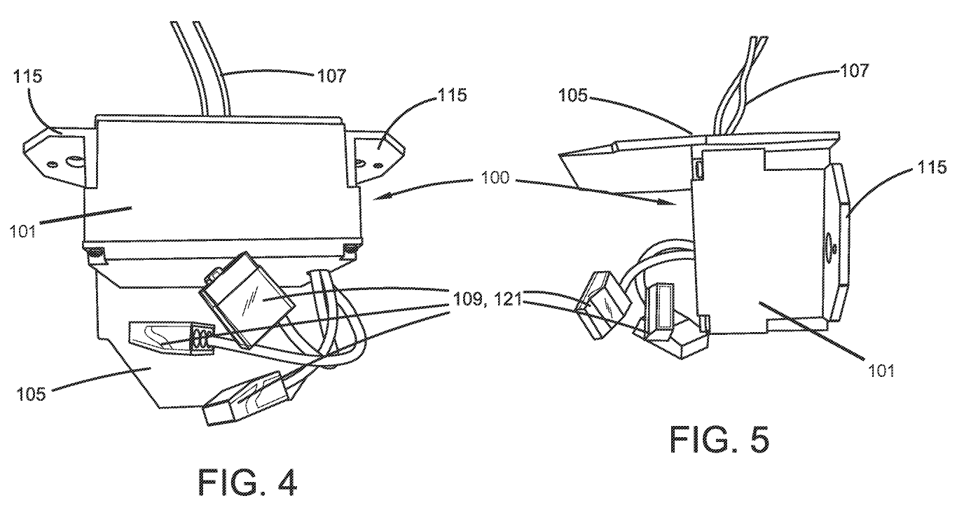

With reference to FIGS. 1-5, the disclosed invention is a power supply adapter 100 configured for “drop in” use within an electrical junction box 103. The power supply adapter 100 includes a converter 101 that receives a high-voltage input via high-voltage input wires 107. The converter 101 transforms the high-voltage input into a low-voltage output and delivers the low-voltage output through corresponding low-voltage output wires 109.

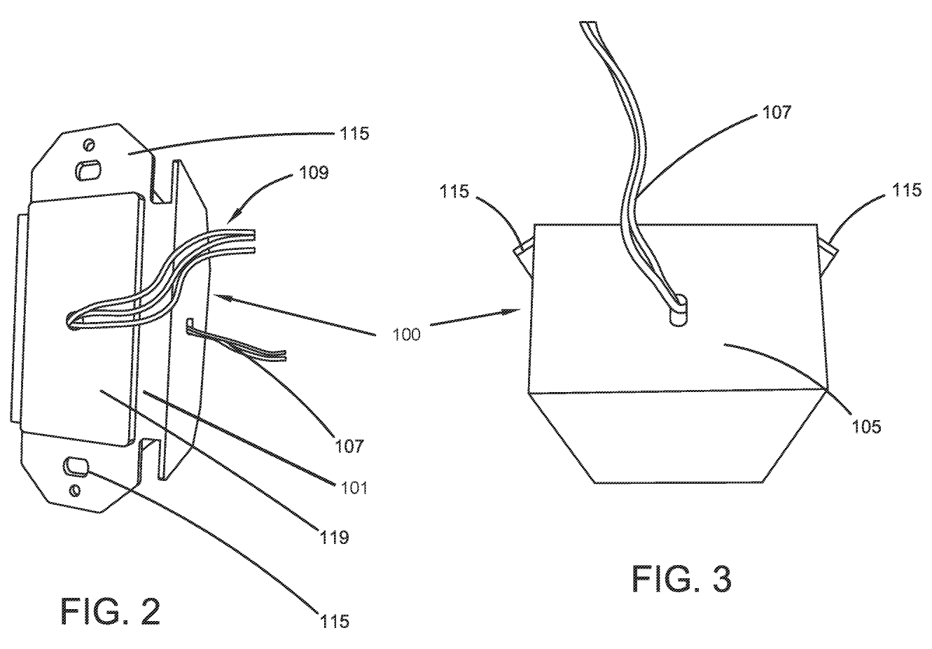

The configuration of the low-voltage output wires 109 may vary depending on the placement of the electrical appliance to which they are connected. As shown in FIG. 1, the low-voltage wires may extend from a rear portion of the converter 101, enabling connection to an appliance wired through the wall to which the junction box 103 is affixed. In FIG. 2-5, the low-voltage output wires 109 are redirected to extend from a front-facing surface of the converter 101 and pass through an orifice 118 in the faceplate 117. This arrangement allows the low-voltage output wires 109 to connect to an appliance located externally to the wall. Removable connectors 121 may be attached to the low-voltage output wires 109 to enable easy disconnection and reconnection between the converter 101 and an electrical appliance. Alternatively, the low-voltage output wires 109 may be permanently wired into an appliance without a removable connector 121.

As shown in FIGS. 1–5, the converter 101 may be enclosed within a fire-resistant and electrically insulative housing 116. The housing 116 surrounds the converter 101 and contains its circuitry in a single compact unit, providing structural support, electrical insulation, and thermal protection. In some embodiments, the housing 116 may be formed as a monolithic structure, meaning that the housing 116 is a single continuous piece molded or manufactured without seams or detachable panels. This monolithic design can enhance structural rigidity, reduce component count, and improve fire and electrical safety compliance.

A separator plate 105 is mechanically coupled to the converter 101 and is shaped to conform to the internal dimensions (discussed below) of an electrical junction box 103. The separator plate 105 divides the interior of the junction box 103 into two distinct subcompartments: a high-voltage subcompartment 111 and a low-voltage subcompartment 113. The two subcompartments are electrically isolated from one another, such that no conductive path other than the high-voltage input wires 107 exists between the high-voltage and low-voltage regions within the junction box 103. The converter 101 is entirely housed within the low-voltage subcompartment, and all low-voltage circuitry and conductors remain within the low-voltage subcompartment.

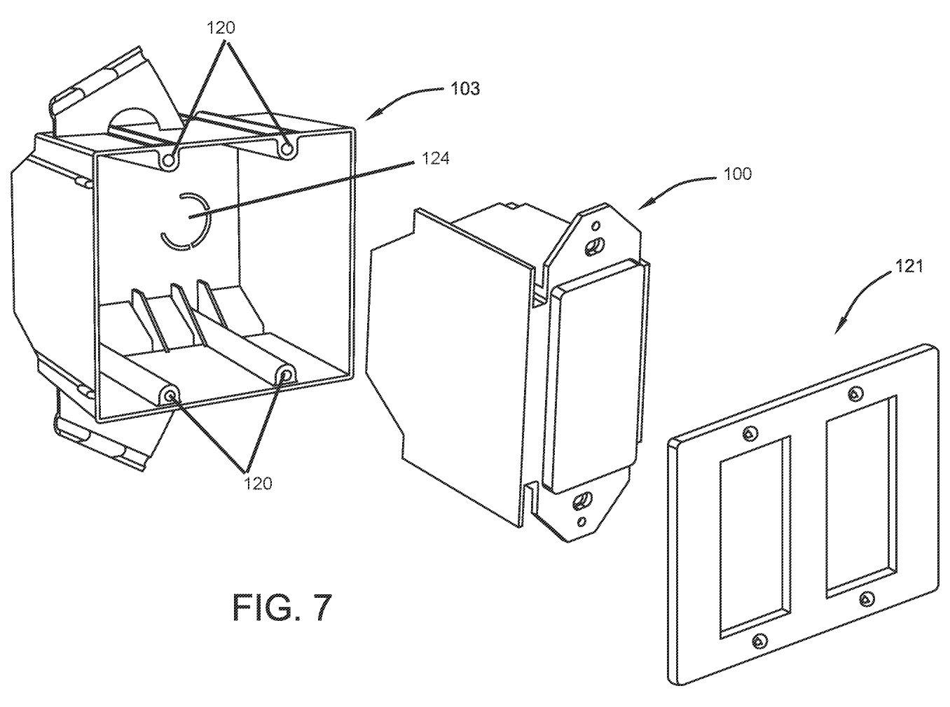

In some embodiments, as shown in FIG. 1, the separator plate 105 is a distinct component or set of components that is mechanically attached to the converter 101 housing 116. In other embodiments, such as that illustrated in FIG. 7, the separator plate 105 may be monolithically formed with the converter 101 housing 116. In monolithic configurations, the housing 116 and separator plate 105 are part of a single integral structure (also referred to as a unitary or monolithic structure), further ensuring physical and electrical isolation between the high-voltage and low-voltage compartments.

One or more connector plates 115 may be mechanically coupled to the converter 101 and provide attachment points to attach the converter 101 to the junction box 103. A faceplate 117 is positioned on a front surface of the converter 101 and optionally includes a central orifice 118 through which the low-voltage output wires 109 may extend to connect with external devices. In some embodiments, the faceplate 117 itself may also be monolithically formed with the converter 101 housing 116, thereby simplifying assembly and increasing mechanical durability. The faceplate of the converter may optionally include features such as integrated indicator lights, test and reset buttons, or keyed slots for standardized low-voltage connectors. In some embodiments, the faceplate or housing may be interchangeable or color-matched for improved visual integration into residential interiors.

### Junction Box

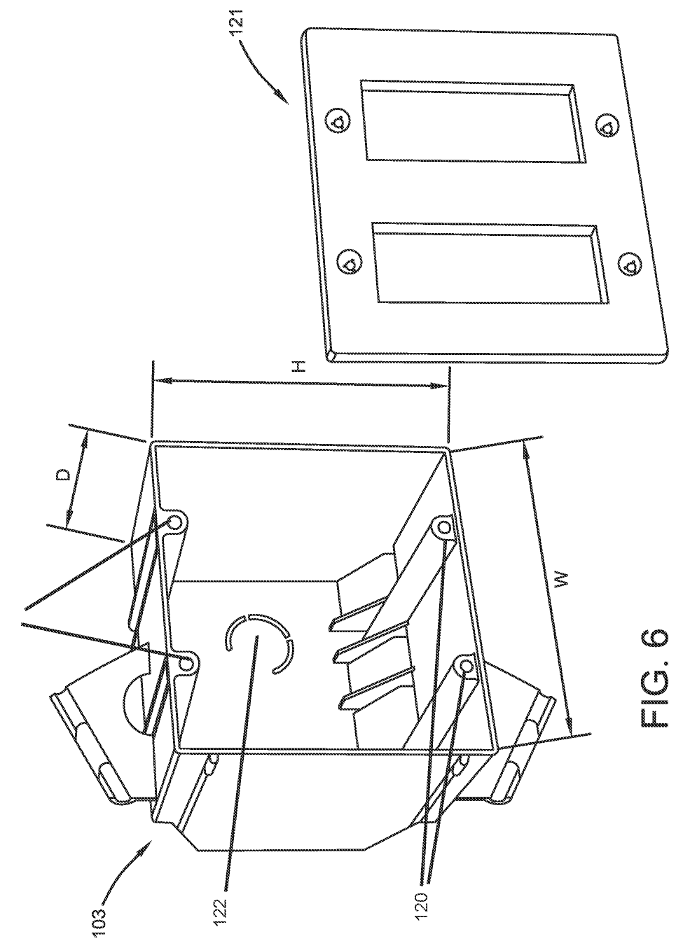

With reference to FIG. 6, an electrical junction box 103 is an enclosure used to house and protect electrical connections, wiring junctions, and electrical devices such as switches, outlets, or power supply modules. Junction boxes 103 comply with at least Article 314 of the NEC code, including volume-fill calculations (e.g., NEC Article 314), conductor protection requirements, and rules governing the combination of circuit types.

Junction boxes 103 are typically installed within the walls, ceilings, or floors of commercial and residential structures, serving both as a physical support structure for electrical components and as a safety barrier that contains potential sparks or electrical faults. Junction box enclosures house a wide range of electrical circuits, including power outlets, light switches, dimmer switches, smart home controllers, communication ports, and low-voltage terminals. Junction boxes 103 are also used to enclose wire splices or connections between circuit branches, ensuring that these junctions remain accessible and protected. Junction boxes are commonly made of fire-resistant materials such as galvanized steel or thermoplastic polymer, in compliance with applicable fire and electrical safety regulations, including those prescribed by the National Electrical Code (NEC). Some purposes of junction boxes include reducing the risk of electrical shock, containing arcs or sparks generated by faults, and preventing the spread of fire through wall cavities or other structural spaces.

Junction boxes 103 come in a variety of sizes and configurations. The most common form is the single-gang box, which accommodates one electrical device. Double-gang boxes are designed to hold two devices side by side, and larger configurations—such as triple-gang or four-gang boxes—are used for installations requiring multiple adjacent devices. A junction box 103 has a junction box height (H), a junction box width (W), and a junction box depth (D). Each "gang" or section of the box corresponds to a discrete unit that internally measures approximately 4 inches in height and 2 inches in width, with a depth ranging from 2.5 to 3.5 inches, depending on the model and manufacturer. As such, a standard double-gang box has an internal junction box height (H) of 4 inches, an internal junction box width (W) of approximately 4 inches, and an internal junction box depth (D) of 2.5 to 3.5 inches. Additional sections are added in width increments of roughly 2 inches per gang.

Junction boxes 103 may include knockouts or access ports 124 to allow safe routing of conductors into and out of the enclosure and commonly include mounting holes 120 or brackets for attaching circuitry like outlets. After electrical circuits are installed within a junction box 103, a cover plate 119 may be attached to the front of the gangbox to enclose the wiring and present a finished appearance that provides further shock and fire resistance to the junction box 103.

As shown in FIG. 7, the power supply adapter 100 of the present disclosure is shaped to be “drop-in” installed into a junction box 103. As used herein, the term “drop-in” refers to a form factor and installation method by which the power supply adapter 100 may be inserted directly into an existing junction box 103 without requiring structural modification to the box or surrounding wall. A drop-in configuration allows the power supply adapter 100 to be installed using the junction box’s 103 existing interior volume and mounting geometry. Once inserted, the adapter may be secured in place using screws, bolts, clips, rivets, adhesives, magnets, or nails, and may be shielded with a cover plate 119 that may attach to the open side of a junction box such that the cover plate 119 lies flush with the converter’s 101 faceplate 117.

The present disclosure’s drop-in design enables the power supply adapter 100 to be compatible with a variety of junction box 103 configurations. Although the illustrated junction box 103 is a double-wide junction box 103, the power supply adapter 100 may be installed within a junction box 103 with any number of gang sections. The power supply adapter 100 may be positioned within the junction box 103 so that the converter’s 101 connector plates 115 align with the junction box 103, allowing the adapter to be affixed to the box using standard mounting holes 120. The front of the converter 101 may be shaped to conform to the dimensions of a cover plate 119 designed to shield the open side of a junction box 103 after installation. As illustrated in FIG. 7, the converter’s 101 faceplate may be shaped to fit through an opening in the cover plate 119 used for shielding junction box 103 outlets. In an alternative embodiment (not shown), the cover plate 119 may be formed monolithic with the housing 116 that surrounds the converter 101.

### Division of junction box into subcompartments

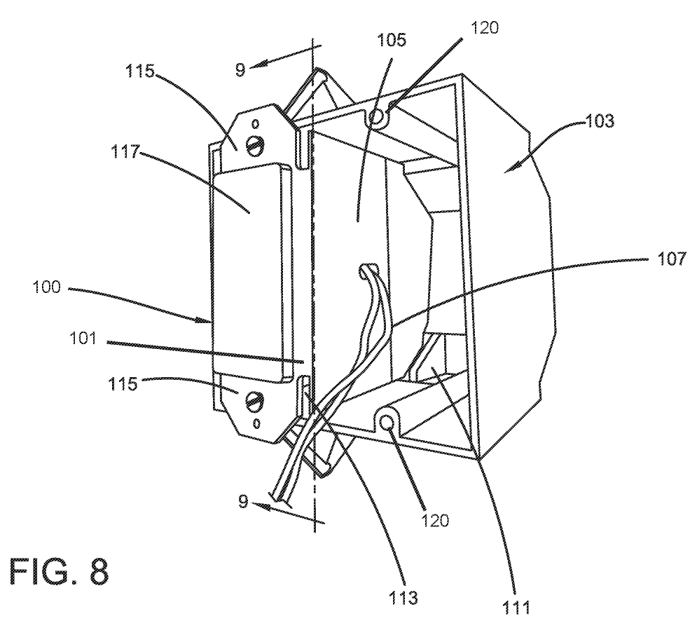

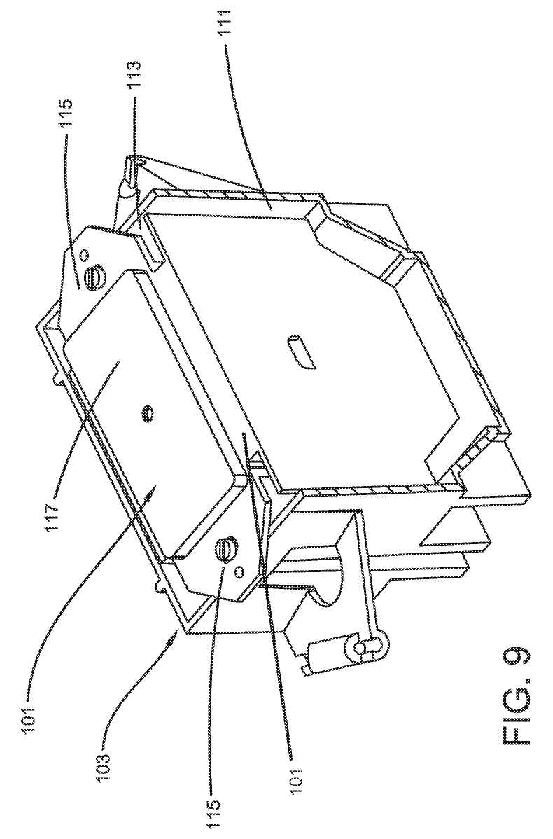

As illustrated in FIGS. 8–9, once the power supply adapter 100 is installed into a junction box 103 with more than one "gang" section (a double-wide junction box is shown in FIG. 8), the separator plate 105 of the converter 101 divides the interior of the junction box 103 into a low-voltage subcompartment containing the converter 101 and a high-voltage subcompartment 111 that is physically separate from the converter 101. The separator plate 105 may be positioned within the junction box 103 such that both the high-voltage and low-voltage subcompartments 111, 113 each correspond to the internal dimensions of a single gang section. In the illustrated configuration, the separator plate 105 effectively delineates a single-gang sized high-voltage subcompartment 111 and a gang-sized low-voltage subcompartment 113 within the multi-gang junction box 103. A screw may be inserted through the connector plate 115 to secure the power supply adapter 100 to the mounting holes 120 of the junction box 103.

High-voltage input wires 107 may enter the junction box 103 through the high-voltage subcompartment 111 and then pass through the separator plate 105 to deliver power to the converter 101. In the embodiment illustrated in FIG. 8, the low-voltage output wires 109 exit the converter 101 into the low-voltage subcompartment 113 before exiting the junction box 103 through one or more access ports 124 located at the rear of the junction box 103.

As shown in FIG. 9, the separator plate 105 is shaped to conform to the internal geometry of the specific junction box 103 into which the power supply adapter 100 is installed. To satisfy NEC code requirements for physical separation of class 1 and class 2/class 3 circuits, the separator plate 105 may be dimensioned to fit flush against the internal surfaces of the junction box 103, thereby forming an electrically isolating barrier between compartments. Although the illustrated embodiment depicts a spade-shaped separator plate 105, the separator plate 105 may be shaped to fit other junction box 103 internal geometries. For example, in alternate embodiments (not illustrated), the separator plate 105 may be semicircular to fit a circular junction box 103 or rectangular to fit a rectangular junction box 103.

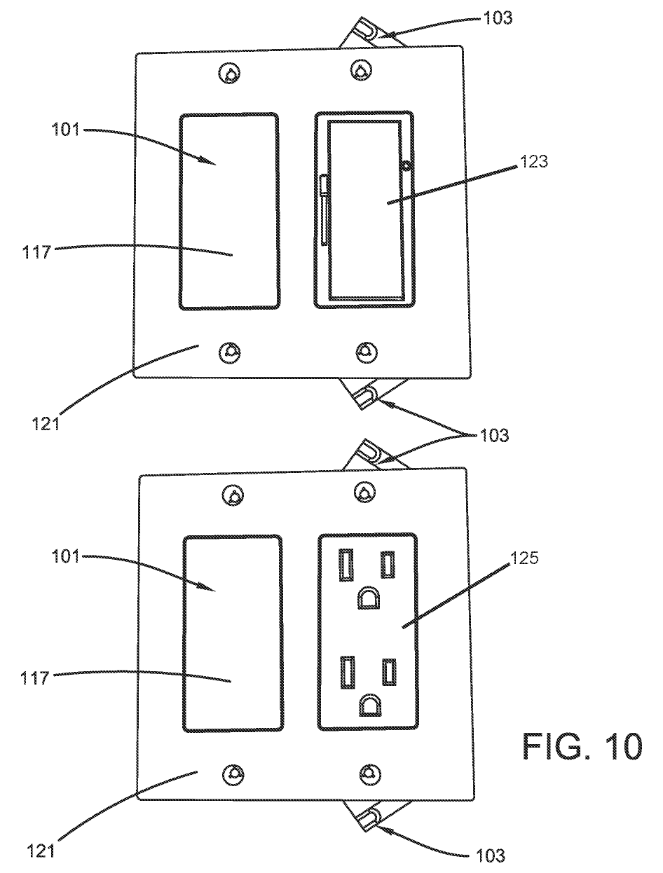

As shown in FIG. 10, a junction box 103 with an installed power converter 101 may include an electrical switch 123 or outlet plug 125 positioned within the high-voltage subcompartment 111 of the junction box 103. In this configuration, the power supply adapter 100 occupies the low-voltage subcompartment 113, while the high-voltage device remains isolated within its own high-voltage subcompartment 111. This arrangement allows both the power supply adapter 100 (which is class 2 circuitry) and class 1 circuitry to coexist within a single junction box 103 while maintaining compliance with NEC requirements for physical and electrical separation between class 1 and class 2 or 3 circuits.

### Power supply adapter use with smoke detectors

The power supply adapter may be included as a component within a smoke detector installation kit (not shown) that is specifically designed to reduce system wiring costs and simplify code-compliant installations in residential or mixed-use structures. The kit may feature a plurality of smoke detectors configured to operate using low-voltage class 2 input power, which allows the use of smaller-gauge wiring and reduces the reliance on copper-intensive class 1 infrastructure. Instead of requiring high voltage class 1 wires to be routed directly to each detector, a drop-in converter is used to locally convert high-voltage class 1 power to low-voltage class 2 power within a central existing junction box, enabling low-voltage wiring to be distributed from the central junction box to each of the smoke detectors in the smoke detection system while maintaining compliance with NEC Code requirements.

The kit may include low-voltage wires, such as 20-gauge or 22-gauge copper conductors, which are used to connect the converter to the smoke detectors and to interconnect the detectors themselves for signal propagation. In many cases, the smoke detectors may communicate using low-voltage signaling protocols, such as serial communication or pulse-based triggering, making them well-suited for more cost-effective class 2 wiring. The use of low-voltage class 2 wires reduces the complexity and cost of installations, especially in residential environments where tight wall spaces (i.e., having limited wall cavity space), aesthetic expectations, and consumer price sensitivity are important considerations. By reducing wire gauge and allowing longer cable runs without needing heavier conduit or dual gangboxes, the system reduces installation costs and installation flexibility.

To further streamline the installation process, the kit may include instructional materials illustrating NEC-compliant wiring arrangements, including recommendations for compartment separation, grounding practices, and low-voltage conductor routing. In some embodiments, printed installation templates or digital guides may be provided to support electricians and contractors in performing safe, code-compliant work. Optional hardware such as covers with low-voltage apertures, mounting brackets, or wiring clips may also be included to ensure a complete system fit for residential deployment.

The smoke detector kit may include a plurality of low-voltage class 2 or class 3 smoke detectors, one or more power supply adapters with high-to-low voltage converters, and the necessary wiring to distribute both power and communication signals throughout the building. The converters may include a separator plate attached to the converter, which divides the interior volume of the junction box into at least two subcompartments, including a low-voltage subcompartment and a high-voltage subcompartment, as explained in the above-provided discussion of the present disclosure’s power supply adapter. The separator plate is mechanically coupled to the converter such that the converter is disposed entirely within the low-voltage subcompartment. The separator plate is formed from a fire-resistant and electrically insulative material, such that the low-voltage subcompartment and the high-voltage subcompartment are created in the junction box by the separator plate, and high-voltage power received by the high-voltage subcompartment is electrically isolated from the low-voltage subcompartment.

The kit may include class 1 power wires to bring high-voltage electricity to the drop-in converter, and class 2 conductors to distribute low-voltage power to the smoke detectors. Because the power supply adapter includes a built-in separator plate, the system enables both high- and low-voltage circuits to coexist within a single junction box while maintaining physical and electrical isolation, thereby avoiding the need for an additional gangbox solely to house the converter.

Alternative embodiments of the system may be designed around either centralized or distributed power conversion strategies. In a centralized configuration, a single drop-in converter may supply multiple smoke detectors using low-voltage wiring routed through walls or ceilings. In a distributed configuration, each junction box may include its own converter, simplifying circuit routing and improving modularity.

Further variants of the system may be tailored for use in retrofit applications where access to existing wiring is limited. The drop-in nature of the converter allows integration into existing single- or double-gang boxes without requiring wall modifications, thereby reducing labor and preserving finish work. The system may also be optimized for use in multifamily houses, townhomes, or mobile homes—contexts where NEC compliance is still mandatory, but cost and space constraints are more stringent. Because class 2 wiring is generally more affordable and easier to install, the ability to use it for both power and signaling functions throughout a smoke detector network offers significant material savings. In residential applications, where both aesthetics and budget are prioritized, the kit's ability to consolidate power and communication into a single junction box 103 offers a competitive advantage over conventional systems requiring separate high-voltage and low-voltage enclosures.

In summary, a power supply adapter 100 is configured for installation within an electrical junction box 103 to enable both high-voltage and low-voltage circuitry to coexist while maintaining compliance with NEC Code requirements. The adapter includes a high-to-low voltage converter 101 and a separator plate 105 that divides the junction box 103 into electrically isolated high-voltage 111 and low-voltage subcompartments 113. The converter 101 is housed entirely within the low-voltage subcompartment 113, and the separator plate 105 is formed from a fire-resistant, electrically insulative material. The power supply adapter 100 reduces installation costs and material usage by allowing low-voltage devices, such as smoke detectors, to be powered from existing high-voltage infrastructure without requiring additional junction boxes 103. The power supply adapter 100 may be used as part of a smoke detector kit comprising low-voltage detectors, interconnecting signal wires, and NEC-compliant installation instructions.

It is to be understood that unless specifically stated otherwise, references to “a,” “an,” and/or “the” may include one or more than one, and that reference to an item in the singular may also include the item in the plural. The phrase “and/or” should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. The word “or” should be understood to have the same meaning as “and/or” as defined above.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a "means") used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A power supply adapter configured for installation within the interior volume of an electrical junction box, comprising:
a converter configured to:
receive a high-voltage input;
convert the high-voltage input to a low-voltage output; and
output the converted low voltage output;
a separator plate configured to divide the interior volume of the junction box into at least two subcompartments including a low-voltage subcompartment and a high-voltage subcompartment;
wherein the separator plate is mechanically coupled to the converter, such that the converter is disposed entirely within the low-voltage subcompartment;
wherein the separator plate is formed from a fire-resistant and electrically insulative material, such that:
the low-voltage subcompartment and the high-voltage subcompartment are created in the junction box by the separator plate; and
high-voltage power received by the high-voltage subcompartment is electrically isolated from the low-voltage subcompartment.

2. The power supply adapter of claim 1, wherein the converter is enclosed within a fire-resistant and electrically insulative housing.

3. The power supply adapter of claim 2, wherein the housing is a monolithic structure.

4. The power supply adapter of claim 2, wherein the separator plate is monolithically formed with the housing.

5. The power supply adapter of claim 2, further comprising a cover mechanically coupled to the converter to seal an opening of the interior volume of the high-voltage subcompartment.

6. The power supply adapter of claim 2, further comprising a cover formed monolithic with the converter to seal an opening of the interior volume of the high-voltage subcompartment.

7. The power supply adapter of claim 2, further comprising a connector plate mechanically coupled to the housing, the connector plate configured to attach to the electrical junction box.

8. The power supply adapter of claim 2, further comprising a connector plate formed integral to the housing, the connector plate configured to attach to the electrical junction box.

9. The power supply adapter of claim 1, wherein the low-voltage output of the converter is removably connected to an electronic device.

10. The power supply adapter of claim 1, wherein the low-voltage output of the converter is permanently wired into an electronic device.

11. The power supply adapter of claim 1, wherein the converter is configured to receive 120 volts AC as the high-voltage input, and output less than 60 volts DC as the low-voltage output.

12. A smoke detector wiring kit, comprising:
a plurality of smoke detectors configured to operate via a low-voltage input power;
a converter configured to:
receive a high-voltage input;
convert the high-voltage input to a low voltage output; and
output the converted low voltage output to the plurality of smoke detectors;
a separator plate configured to divide the interior volume of the junction box into at least two subcompartments including a low-voltage subcompartment and a high-voltage subcompartment;
wherein the separator plate is mechanically coupled to the converter, such that the converter is disposed entirely within the low-voltage subcompartment;
wherein the separator plate is formed from a fire-resistant and electrically insulative material, such that:
the low-voltage subcompartment and the high-voltage subcompartment are created in the junction box by the separator plate; and
high-voltage power received by the high-voltage subcompartment is electrically isolated from the low voltage subcompartment.

13. The kit of claim 12, further comprising a plurality of low-voltage signal wires for communicatively interconnecting the smoke detectors to the converter.

14. The kit of claim 12, wherein the converter is enclosed within a housing.

15. The kit of claim 14, wherein the housing is a monolithic structure.

16. The kit of claim 15, wherein the separator plate is monolithic with the housing.

17. The kit of claim 12, further comprising installation instructions specifying NEC-compliant routing of high-voltage and low-voltage conductors.

18. The kit of claim 12, wherein the converter is configured to receive 120 volts AC as the high-voltage input and output less than 60 volts DC as the low-voltage output.

19. The kit of claim 12, further comprising a cover mechanically coupled to the converter to seal an opening of the high-voltage subcompartment.
